(19) United States
(12) Patent Application Publication
(10) Pub. No.: US 2005/0154626 A1
(43) Pub. Date: Jul. 14, 2005

(54) Dynamic window vehicle tracking method

(76) Inventor: Mike Jones, Manitoba (CA)

Correspondence Address: ADE & COMPANY, 1700-360 MAIN STREET, WINNIPEG, MB, R3C3Z3, CA

(21) Appl. No.: 10/753,872

(22) Filed: Jan. 9, 2004

(51) Int. Cl. G06F 19/00

(52) U.S. Cl. 705/8

(57) ABSTRACT

Described herein is a shipment schedule tracking system which locates, tracks and estimates the arrival time of a shipment to its destination based on a plurality of factors. If this projected arrival time differs from the expected arrival time by a variable threshold value which is determined by the distance remaining to the destination, an alert is forwarded to the dispatch office so that appropriate steps can be taken.

### PRIOR APPLICATION

The instant application claims priority on U.S. Ser. No. 60/438,512, filed Jan. 8, 2003.

### FIELD OF THE INVENTION

The present invention relates generally to the field of vehicle tracking and scheduling.

### BACKGROUND OF THE INVENTION

As discussed below, there are several vehicle tracking methods described in the prior art. However, many of these are concerned primarily with ensuring that a predetermined route is followed or with announcing the impending arrival of a mass transit vehicle.

For example, U.S. Pat. No. 5,751,245 teaches a method for determining whether or not a vehicle is following its predetermined route or schedule. The use of a compliance corridor is also taught wherein whenever the vehicle deviates a predetermined amount from its intended route, the base station is notified. Also taught is using specific waypoints to determine whether or not the vehicle is reaching waypoints at the scheduled times.

Similarly, U.S. Pat. No. 5,068,656 teaches a system and method for monitoring and reporting out-of-route mileage for trucks wherein a truck leaving or not being within a predetermined area of the intended route is again reported to the base.

U.S. Pat. No. 6,317,060 teaches a vehicle monitoring and notification system which notifies connected stations of impending arrivals. The method also teaches the use of check points or way points to determine if a vehicle is behind schedule which occurs when the vehicle is more than a set period of time behind schedule.

U.S. Pat. Nos. 6,088,650 and 5,987,378 teach a method for monitoring location and speed of a vehicle wherein any vehicle arrest for a period longer than a threshold amount is noted along with the location of the vehicle at the time of the arrest and the mileage. This information is stored and is subsequently reported to the dispatcher.

U.S. Pat. No. 5,541,845 teaches a method for monitoring the movement of a vehicle along a selected route. In this method, a time schedule is prepared for reaching weigh points on a predetermined path and can also be used to generate an electronic map wherein the vehicles position along the path is noted.

U.S. Pat. No. 5,657,010 teaches an advance notification system arranged to be used with mass transit vehicles such as school buses wherein the impending arrival of the vehicle at a given waypoint is estimated and this information is made available to connected users.

Others have described methods of notifying drivers or dispatchers of delivery trucks or long-haul trucks that a delivery schedule is not being met or will not be met.

For example, U.S. Pat. No. 5,987,377 describes a system for determining the expected arrival time of a vehicle. The mobile unit calculates an expected time of arrival and reports this to the dispatch unit. The dispatch unit compares this value to the scheduled time of delivery and notes if these values differ by greater than a threshold number which is determined “based on the importance of vehicle arriving at a destination on or before the appointment time” (U.S. Pat. No. 5,987,377, column 7, lines 31-35). U.S. Pat. No. 5,987,377 also notes that “just because mobile unit determines that the expected time of arrival of vehicle is later than the appointment time after one calculation does not mean that the vehicle will definitely be late . . . . Thus, dispatch is operable to configure a failure count parameter, defined as the number of calculations of expected times of arrival in a row that are later than the appointment time” (column 7, lines 3543). Thus, this patent notes that over time, a behind schedule vehicle may make up enough time to get back on schedule but proposes no solution to this problem other than ignoring a number of alerts.

However, these static methods are not suitable for long-distance shipping. As will be appreciated by one of skill in the art, if an important shipment is projecting to be 30 minutes late at an early stage of a long trip, it is not an urgent situation because the driver has a considerable amount of time to get back on schedule. However, this ability to make up time decreases as the vehicle nears its destination. Clearly, a tracking system that recognizes this is needed.

### SUMMARY OF THE INVENTION

According to a first aspect of the invention, there is provided a system for tracking the schedule of a shipping vehicle, said shipping vehicle having a shipment delivery time at a destination, said system comprising:
a shipment terminal within the shipping vehicle, said shipment terminal comprising:
   an input device for entering data;
   an output device for displaying alerts;
   a locator for determining a current location of the shipping vehicle; and
   a compiler for determining estimated time of arrival at the destination based on the current location;
a dispatch terminal arranged to compare the shipment delivery time, the estimated delivery time and the distance from the current location to the destination and determine if the shipment will be late; and
a communications link connecting the dispatch terminal and the shipment terminal for communication therebetween.

According to a second aspect of the invention, there is provided a method of determining if a shipment on a shipping vehicle will be delayed comprising:
providing a shipment delivery time for a shipment at a destination;
determining the current position of the shipment;
calculating the distance between the current position and the destination;
determining a dynamic window of acceptable location for the shipment based on the scheduled location of the shipment and the distance to the destination; and
notifying a dispatch office if the current position of the shipment is outside said window.

### DESCRIPTION OF THE PREFERRED EMBODIMENTS

As used herein, “shipping vehicle” refers to a vehicle carrying a shipment. As will be appreciated by one of skill in the art, the shipping vehicle may be, for example, a container, a trailer, a truck or a train.

As used herein, “shipment” refers to cargo carried by a shipping vehicle. A group of shipments may be combined to create a single schedule composed of multiple destinations and/or delivery times for the vehicle carrying the consolidation of shipments. If an individual shipment has a schedule, the vehicle carrying that shipment inherently has a schedule. In some instances, the individual shipment schedule may not coincide with the vehicle schedule. That is, a shipment may be expected or needed by the receiver at a given time, but the shipping vehicle may be expected at a terminal at an earlier time. Alternatively, the vehicle may contain multiple shipments, each with a different destination and schedule.

As used herein, “driving hours” refers to the maximum number of hours a driver or team of drivers can drive over a given period of time, As will be appreciated by one of skill in the art, the available driving hours depends on factors such as for example but by no means limited to previous hours driven and local restrictions and regulations on permissible hours of service.

As used herein, travel time refers to number of driving hours minus time spent on delays, such as weighing stations, refuelling, customs stations, toll booths, number of stops between current location and destination and the like. It is of note that travel time may refer to anticipated travel time or corrected travel time.

As used herein, corrected average speed refers to maximum allowable vehicle speed compensating for factors which reduce speed such as urban traffic, high traffic levels, and road construction.

As used herein, “shipment schedule” refers to the delivery time for a specific shipment or group of shipments on a shipping vehicle.

As used herein, “vehicle schedule” refers to when a shipping vehicle should arrive at a destination.

Described herein is a shipment schedule tracking system which locates, tracks and estimates the arrival time of a shipment and/or a shipping vehicle to its destination based on a plurality of factors. These factors include route-dependent factors, such as border crossings and urban congestion, time-dependent factors, such as fuel stops and construction and variable factors, such as weather conditions, If this projected arrival time differs from the expected arrival time by a variable threshold value, which is dependent on the distance remaining to the destination, an alert is forwarded to the dispatch office so that appropriate steps can be taken, for example, notifying the driver that the shipment is outside of the acceptable delivery window and/or notifying the receiver that the shipment will be delayed.

Thus, it is an object of the invention to provide a dispatch office with information about the on-time status of a specific shipment or a shipping vehicle, even in situations where the shipping vehicle does not have a predetermined route and/or schedule.

It is important to note that, as described above, an individual shipment may or may not have a schedule. A group of shipments may be combined to create a single schedule for the vehicle carrying the consolidation of shipments. If an individual shipment has a schedule, the vehicle carrying that shipment inherently has a schedule. In some instances, the individual shipment schedule may not coincide with the vehicle schedule, as discussed above. This invention differentiates between shipment schedules and vehicle schedules. The system alarms differentiate between these schedules and are set when exceptions are noted. The alarm is directed to the dispatch office advising staff to monitor the situation and/or take action, as described below.

In one embodiment, the system comprises a shipment terminal, a communications link and a dispatch terminal. The shipment terminal comprises a locator and a compiler.

The communications link couples the dispatch terminal and the shipment terminal for communication therebetween. The communications link may be any land-based or spaced-based communications system, for example, a mobile or cellular phone system, a combination of dedicated telephone lines, switched telephone lines, microwave communications links, satellite-based communications links, specialized mobile radio (SMR), enhanced specialized mobile radio (ESMR), a personal communications service (PCS), a citizen's band (CB) or any other suitable communications link that allows the dispatch terminal to transmit data to or receive data from the shipment terminal.

The shipment terminal may be mounted in a shipping container and/or within the shipping vehicle. In some embodiments, shipment terminals within shipping containers may be arranged to communicate directly with a shipment terminal in the shipping vehicle so that several shipments within a consolidation of shipments may be tracked simultaneously. In yet other embodiments, the shipping vehicle may have a locator mounted therein, as discussed below.

The locator is a positioning system for example, the NAVSTAR global positioning system (GPS), a land-based LORAN-C, a space-based GLONASS, a dead reckoning system, an inertial navigation system, or any other appropriate positioning technology.

The compiler manages the communicating, calculating and locating of the shipment terminal. Coupled to the compiler is memory which may contain programs, maps, databases, and other information required by the compiler. Memory may be random access memory (RAM), read-only memory (ROM), CD-ROM, removable memory devices, or any other device that allows storage or retrieval of data. The compiler further includes at least one output device and at least one input device. The output device reports information calculated by the compiler as well as in some embodiments information from the dispatch terminal. The output device may be an audio device, such as speakers, a visual device such as a monitor or screen, other communication device or a combination thereof. The input device may be a keypad, touch screen, voice recognition software and hardware that can accept audible commands or a combination thereof. Furthermore, both the output device and the input d vice may include fixed or removable storage media, such as magnetic computer discs, CD-ROM, or other suitable media to both receive output from and provide input to the compiler or the memory.

As discussed below, the shipment terminal is also used for forwarding driver data to the dispatch office using the input device. Examples of information forwarded include but are by no means limited to Estimated Times of Arrival (ETA), and Hours of Service or driver hours. This information is used to determine the exception alarms, as described below.

The dispatch terminal sends alerts, and is arranged to receive and transmit data and information from the shipment terminal. The dispatch terminal includes memory which may contain programs, maps, databases, and other information required. Memory may be random access memory (RAM), read-only memory (ROM), CD-ROM, removable memory devices, or any other device that allows storage or retrieval of data. The dispatch terminal may further include at least one output device and at least one input device. The output device reports information such as alerts forwarded by a shipment terminal, as described below. The output device may be an audio device, such as speakers, a visual device such as a monitor or screen, other communication device or a combination thereof. The input device may be a keypad, touch screen, voice recognition software and hardware that can accept audible commands or a combination thereof. Furthermore, both the output device and the input device may include fixed or removable storage media, such as magnetic computer discs, CD-ROM, or other suitable media to both receive output from and provide input to the compiler or the memory. It is of note that the dispatch terminal may include software or hardware to forward alerts to other terminals or devices. The dispatch terminal may further include a voice synthesizer or recorded messages for automatically notifying vehicle drivers or shipment receivers of alerts, as described below.

The invention is an exception-based module that assists in the identification of potentially late status of shipping vehicles. The invention is a set of triggers that are proactively activated when the estimated time of arrival of a shipping vehicle falls outside the pre-determined delivery time by a variable value, that is, falls outside a dynamic window. As discussed herein, these exceptions may be vehicle based or may be shipment based.

As discussed herein, the dynamic window is essentially the anticipated location of a shipping vehicle given ideal conditions. When a shipping vehicle falls outside the dynamic window, an exception is reported. The dynamic window tracks the location of the shipping vehicle and compares this actual location with its ideal location, given specified criteria. It is of note that in some embodiments this comparison may be continuous or done at frequent intervals so that it is effectively continuous. In other embodiments, the comparison may be done at regular or irregular intervals. In yet other embodiments, the frequency of the comparison may increase as the shipping vehicle nears its destination and/or scheduled delivery time. The variance around the ideal location of the shipping vehicle depends on a number of criteria including: travel time corrected for delays, for example, but by no means limited to stops for weighing stations, refuelling, customs stations, and toll booths, number of stops between current location and destination and the like; and corrected average speed including maximum allowable vehicle speed adjusted for factors which reduce speed, for example, but by no means limited to urban traffic, high traffic levels, and road construction.

In use, the compiler determines the ideal position of the shipment at the current time. This may be based on hours travel times average speed or may be based on a schedule assuming a predetermined amount of travel each day.

This information is forwarded to the dispatch terminal which then compares the ideal position to the position of the shipment and the distance left to the destination as determined by the locator to determine if the current location of the shipment falls within the acceptable window. If the current location does not fall within the acceptable window, an alert is forwarded to the dispatch office.

The number of miles remaining to destination is calculated by the compiler using data from the locator. As discussed above, this value is used to determine the dynamic window value for reporting an exception. The Shipment Appointment time is provided to the shipment terminal by the dispatch terminal at the time of departure or may be updated during the trip. The Expected Time of Arrival for the shipment is estimated by determining the anticipated travel time and the corrected average speed. The anticipated travel time is based on the number of driver hours of service available (which may be, for example, entered by the driver of the shipping vehicle using the input device of the compiler as discussed above, or may be estimated by the dispatch office) taking into consideration driving time lost due to stops, such as stopping at waypoints, for example but by no means limited to, delivery sites, border crossings, toll booths, meat inspection sites, fuel stops, weigh scales and the like. As will be appreciated by one of skill in the art, the available driver hours will depend on how many hours the driver can drive under local regulations, whether the driver is alone or not, and other factors. As discussed above, these parameters may be entered by the driver of the vehicle, may be based on information derived from mapping or route planning software, provided by the dispatch office, other drivers or the internet, or may be estimated or based on averages. The maximum allowable shipping vehicle speed is then calculated, based on the route taken taking into consideration delays which reduce speed, for example but by no means limited to road construction or urban traffic congestion. As will be appreciated by one of skill in the art, urban congestion is dependent on both the time of day and the relative size of the city.

As discussed above, the travel time is calculated based on the available driver hours. Next, route specific exemptions are factored in. For example, when using a specific route, a shipping vehicle may have to cross a border or pass through an urban center. Crossing a border may take 30 minutes, which is deducted from the available travel time for the driver or alternatively added to the expected arrival time. As will be apparent to one of skill in the art, whether expected arrival time or available travel time is used is a matter of perspective. It is also of note that in some embodiments, the border crossing time may vary according to time of day or may be updated based on reports for example from the internet, other drivers or the dispatch office or may be location dependent, that is, dependent on typical volumes of traffic associated with a specific border crossing location. Travelling through an urban center will slow down the shipping vehicle, and the correction applied may be weighted according to the size of the urban centre and the time of day when the vehicle travels through. That is, the larger the urban center, the longer the shipping vehicle will be at a lower speed; similarly, driving through an urban centre in off-peak hours will result in few r d lays which may be factored into the calculation.

Next, distance-dependent exemptions are factored in. Specifically, the longer the distance to be travelled, the more likely it is that the driver will need to stop for refuelling, or will encounter other delays such as road construction and weigh stations. Typically, each distance-dependent exemption is given a percentage chance of occurring or is designated as occurring every certain number of miles. In cases wherein the shipping vehicle is effectively stopped, for example, at a weigh station or for refuelling, a set period of time may be deducted from the driving time. In cases where for example construction is encountered, the maximum speed may be decreased.

Finally, other random exemptions may be incorporated or may be factored into the shadow, for example, weather conditions which are unsuitable for driving. Specifically, alerts regarding weather conditions, for example, high winds, snow, freezing rain, heavy rain, flooding and the like may be forwarded to the shipping vehicle by the dispatch. This information can be used to notify the driver, for example, that an alternate route should be taken, that driving time should be maximized while the weather holds, while also correcting the average speed in view of the changing conditions. It is also of note that specific weather conditions may be weighted more heavily based on the region in which they occur. That is, the delays caused by for example snow in the mountains would be greater than snow on the prairies. Similarly, weather-associated delays may be more heavily weighted during specific seasons or times of the year.

The formula thus calculates corrected travel time (available travel time minus exceptions which reduce the travel time available to the driver) and corrected maximum speed (maximum speed corrected for delays due to for example construction and traffic). This is in turn used to project where the shipping vehicle should be at any given time during transit, This position is expressed not as a single point but as an “acceptable window” which as discussed herein is a variable size, specifically, decreasing in size as the scheduled time approaches. That is, as discussed herein, when there is more time remaining in a trip, the driver has more opportunity to make up time. As a consequence, the acceptable window is larger. However, as the scheduled time approaches and the remaining time of the trip decreases, the opportunities for the driver to make up time decrease and consequently the window shrinks.

This formula provides the dispatch office with an Expected Time of Arrival (ETA) for each shipping vehicle. The proactive component is introduced when specific Shipment Appointment Times (SAT) are compared against the ETA. In instances where the ETA is earlier than the SAT, no exception is generated. In instances where the ETA is later than the SAT, an exception is generated at the dispatch terminal and routed to a specific user. The shipping terminal is also programmed to receive exceptions from the dispatch terminal.

It is of note that shipment may be monitored in real time, at regular intervals or with increasing frequency as the deadline of the vehicle schedule approaches.

It is of note that the terminal may be within the shipping vehicle, for example, a truck or train, or may be within the shipment or shipment container itself.

In one embodiment, for illustrative purposes only, the window is a threshold based on number of miles remaining on the trip. For example, if the shipment is 0-250 miles away and the shipment is more than 0.1 hrs late, an alarm is sounded. If the shipment is 251-500 miles away and projects to be more than 1.5 hrs late, an alarm is sounded. If the shipment is 501-1000 miles away and more than 2.5 hrs late, an alarm is sounded. If the shipment is 1001-2000 miles from its destination and projects to be more than 4.5 hrs late, an alarm is sounded. Finally, if the shipment is more than 2001 miles from its destination and is estimated to be more than 6.5 hrs late, an alarm is sounded.

In some embodiments, to minimize communications between the shipping terminal and the dispatch office, only exceptions are communicated. The system automatically notifies the central office whenever a shipping vehicle falls outside the dynamic window. A strategy to make communication more efficient is for the dispatch terminal to route the exception to specific dispatch office staff, staff that is capable of taking corrective action. This may involve notifying the driver that steps must be taken to get back on schedule—for example, more hours must be driven, the delivery schedule must be altered or fewer stops must be made. Alternatively, the dispatch office may notify the receiver of the shipment that the shipment has been delayed. As discussed above, it is of note that these notifications may be automated.

It is of note that other parameters may also be considered when reporting an exception or may be reported by the system if they fall outside acceptable ranges. For example, the speed of the vehicle may be monitored, any unexpected vehicle arrest for a period longer than a threshold amount may be reported or a departure alert may be sent when a shipping vehicle does not leave by a prescribed time.

While the preferred embodiments of the invention have been described above, it will be recognized and understood that various modifications may be made therein, and the appended claims are intended to cover all such modifications which may fall within the spirit and scope of the invention.

1. A system for tracking the schedule of a shipping vehicle, said shipping vehicle having a shipment delivery time at a destination, said system comprising:
a shipment terminal within the shipping vehicle, said shipment terminal comprising:
an input device for entering data;
an output device for displaying alerts;
a locator for determining a current location of the shipping vehicle; and
a compiler for determining estimated time of arrival at the destination based on the current location;
a dispatch terminal arranged to compare the shipment delivery time, the estimated delivery time and the distance from the current location to the destination and determine if the shipment will be late; and
a communications link connecting the dispatch terminal and the shipment terminal for communication therebetween.

2. A method of determining if a shipment on a shipping vehicle will be delayed comprising:
providing a shipment delivery time for a shipment at a destination;
determining the current position of the shipment;
calculating the distance between the current position and the destination;
determining a dynamic window of acceptable location for the shipment based on the scheduled location of the shipment and the distance to the destination; and
notifying a dispatch office if the current position of the shipment is outside said window.
